(19) United States
(12) Patent Application Publication
(10) Pub. No.: US 2022/0041467 A1
(43) Pub. Date: Feb. 10, 2022

(54) Filtration Media And Filtration Arrangement And Method For Removal Of PFAS Contaminants

(71) Applicant: ENVIRONMENTAL WATER SOLUTIONS PTY. LTD., Wangara (AU)

(72) Inventor: Suzanne Dodds, Wangara (AU)

(21) Appl. No.: 17/393,128

(22) Filed: Aug. 3, 2021

(30) Foreign Application Priority Data
Aug. 5, 2020 (AU) 2020902753
Jul. 22, 2021 (AU) 2021206880

(51) Int. Cl. C02F 1/00; C02F 1/58; C02F 1/28

(52) U.S. Cl. CPC C02F 1/004; C02F 1/58; C02F 2101/36; C02F 2201/006; C02F 2301/08; C02F 1/281

(57) ABSTRACT

A filtration arrangement for removing PFAS contaminants from water is described. The filtration arrangement includes at least one first filtration cartridge and at least one second filtration cartridge arranged for series flow therethrough. The first filtration cartridge comprises a first filtration body having a first filtered water outflow port, a first inflow port for receiving influent water or for receiving filtered water from the first filtered water outflow port of an immediately preceding first filtration cartridge, and a first filtration media contained within the first filtration body, said first filtration media comprising a mixture of calcined attapulgite clay, activated carbon and, optionally, a kinetic degradation fluxion media (KDF). The second filtration cartridge comprises a second filtration body having a second filtered water outflow port, a second inflow port for receiving filtered water from the first filtered water outflow port of an immediately preceding first filtration cartridge or from the second filtered water outflow port of an immediately preceding second filtration cartridge, and a second filtration media comprising an ion exchange resin and optionally activated carbon, contained within the second filtration body.

### TECHNICAL FIELD

The present disclosure relates to a filtration media and a filtration arrangement and method for removal of PFAS contaminants, in particular for point-of-entry drinking water treatment.

### BACKGROUND

The following discussion of the background to the invention is intended to facilitate an understanding of the invention. However, it should be appreciated that the discussion is not an acknowledgement or admission that any of the material referred to was published, known or part of the common general knowledge as at the priority date of the application.

Polyfluoralkylated substances (PFAS) are man-made chemicals that are found in a wide range of products used by consumers and industry. Many PFAS are resistant to grease, oil, water and heat and have found a variety of applications in stain- and water-resistant fabrics and carpeting, cleaning products, paints, and fire-fighting foams.

They are persistent in the environment and do not break down, resulting in increasing levels of environmental contamination. Consequently, they have become a ubiquitous environmental contaminant and can be found in food packaged in PFAS-containing materials, or grown in PFAS-contaminated soil or water, groundwater at airports and military bases where firefighting training occurs, and drinking water which is associated with a specific facility such as a manufacturer, landfill, wastewater treatment plant, firefighter training facility. Current evidence suggests that bioaccumulation of certain PFAS may cause serious health conditions.

The EPA's 2016 Lifetime Health Advisory has established heath advisory levels of 70 parts per trillion in drinking water to maintain a margin of protection from a life-time of exposure to PFOA and PFOS. There are a number of option to treat drinking water systems to lower concentrations of PFOA and PFOS in the drinking water supply including closing contaminated wells, changing rates of blending of water sources, or treating source water with activated carbon or high pressure membrane systems (e.g. reverse osmosis) to remove PFOA and PFOS from drinking water.

Current home drinking water treatment units may be point-of-use (POU) and predominantly use activated carbon and reverse osmosis systems. Home drinking water treatment systems may be certified as meeting NSF/ANSI Standards 53 and 58 by meeting minimum requirements which involve treating an influent of 1.5±30% μg/L (total of PFOA and PFOS) and subsequently reducing this concentration by more than 95% to 0.07 μg/L or less (total of PFOA and PFOS).

In a real world setting, however, the influent also contains other contaminants such as chloride, fluoride, organics and broad spectrum PFAS contaminants. A home drinking water treatment arrangement based on activated carbon alone suffers from PFAS breakthrough in relatively short periods of time and does not remove trace or low levels of broad spectrum PFAS contaminants.

The filtration media, filtration arrangement and method for removing PFAS contaminants as described herein seek to alleviate some of the aforementioned problems.

### SUMMARY

The present disclosure provides a filtration arrangement, a method for removal of PFAS contaminants from point-of-entry drinking water and a filtration media.

In one aspect of the invention there is provided a filtration arrangement for removing PFAS contaminants from water, the filtration arrangement comprising:

at least one first filtration cartridge and at least one second filtration cartridge arranged for series flow therethrough,

the first filtration cartridge comprising a first filtration body having a first filtered water outflow port, a first inflow port for receiving influent water or for receiving filtered water from the first filtered water outflow port of the preceding first filtration cartridge, and a first filtration media contained within the first filtration body, said first filtration media comprising a mixture of calcined attapulgite clay, activated carbon and, optionally, a kinetic degradation fluxion media (KDF),

the second filtration cartridge comprising a second filtration body having a second filtered water outflow port, a second inflow port for receiving filtered water from the preceding first filtered water outflow port or from the second filtered water outflow port of the preceding second filtration cartridge, and a second filtration media comprising an ion exchange resin and optionally activated carbon contained within the second filtration body.

In some embodiments, the ion exchange resin may be mixed with activated carbon. In other embodiments, the ion exchange resin may be arranged in a bed in the second filtration body between beds of activated carbon disposed adjacent to the second inflow port and the second filtered water outflow port of the second filtration body, respectively. In these particular embodiments, the activated carbon may occupy up to one third bed volume of the second filtration body.

In one embodiment, the ion exchange resin comprises an anion exchange resin. Suitable examples of anion exchange resins include, but are not limited to, styrene-divinylbenzene copolymer resins that have quaternary ammonium functional groups.

In one embodiment, the filtration arrangement further comprises a pre-filter cartridge comprising a filter body having a water inflow port for receiving a water inflow from a water supply system, a pre-filtered water outflow port and a pre-filtration media within the filter body, the pre-filter cartridge being arranged in series flow to precede a first of the at least one first filtration cartridges, whereby the first water inflow port of said first filtration cartridge is arranged to receive pre-filtered water from the pre-filtered water outflow port.

In some embodiments, the filtration arrangement further comprises a post-treatment filter cartridge arranged in series flow to receive filtered water from a final second filtration cartridge of the filtration arrangement defined above. The post-treatment filter cartridge may contain a filtration media comprising a pH-balancing media.

In another aspect of the invention there is provided a filtration cartridge having a filtration body comprising a filtered water outflow port, a water inflow port for receiving water, and a first filtration media within the filtration body, said first filtration media comprising a mixture of calcined attapulgite clay, activated carbon and, optionally, a kinetic degradation fluxion media (KDF).

In another aspect of the invention there is provided a method for removing PFAS contaminants from water, the method comprising:

passing an inflow of water from a water supply through a first filtration media comprising a mixture of calcined attapulgite clay, activated carbon and, optionally, a kinetic degradation fluxion media, and
passing an outflow of filtered water from the first filtration media through a second filtration media comprising an ion exchange resin, optionally in combination with activated carbon to produce PFAS-free water.

In one embodiment, the method further comprises pre-treating the inflow of water from the water supply prior to passing said inflow through the first filtration media, wherein pre-treating said inflow comprises passing said inflow through a mechanical filter media.

In another embodiment, the method further comprises post-treating an outflow of water from the second filtration media, wherein post-treating said outflow comprises passing said outflow through a post-treatment bed comprising a pH-balancing media.

In one aspect of the invention there is provided a filtration media comprising a mixture of calcined attapulgite clay, activated carbon and, optionally, a kinetic degradation fluxion media (KDF).

In one embodiment the calcined attapulgite clay have a particle size range from about 0.9 mm to about 0.25 mm. In another embodiment, the calcined attapulgite clay may have a particle size range from about 1.4 mm to about 3.35 mm.

In one embodiment, the calcined attapulgite clay comprises attapulgite clay calcined at about 700° C. for about 1 hour. The calcined attapulgite clay may have a surface area greater than about 90 m²/g.

In one embodiment, the KDF media comprises KDF-55.

In one embodiment, the filtration media comprises a mixture of 5-10 wt % calcined attapulgite clay, 85-95 wt % activated carbon and 0-5 wt % KDF media.

In another aspect of the disclosure there is provided a use of a filtration media comprising calcined attapulgite clay, activated carbon and, optionally, a kinetic degradation fluxion media for removal of PFAS contaminants from water.

### BRIEF DESCRIPTION OF DRAWINGS

Preferred embodiments will now be further described and illustrated, by way of example only, with reference to the accompanying drawings in which:

FIG. 1 is a schematic representation of one embodiment of a filtration arrangement as disclosed herein; and

### DESCRIPTION OF EMBODIMENTS

The present disclosure relates to a filtration media and a filtration arrangement and method for removal of PFAS contaminants.

### General Terms

Throughout this specification, unless specifically stated otherwise or the context requires otherwise, reference to a single step, composition of matter, group of steps or group of compositions of matter shall be taken to encompass one and a plurality (i.e. one or more) of those steps, compositions of matter, groups of steps or groups of compositions of matter. Thus, as used herein, the singular forms “a”, “an” and “the” include plural aspects unless the context clearly dictates otherwise. For example, reference to “a” includes a single as well as two or more; reference to “an” includes a single as well as two or more; reference to “the” includes a single as well as two or more and so forth.

Each example of the present disclosure described herein is to be applied mutatis mutandis to each and every other example unless specifically stated otherwise. The present disclosure is not to be limited in scope by the specific examples described herein, which are intended for the purpose of exemplification only. Functionally-equivalent products, compositions and methods are clearly within the scope of the disclosure as described herein.

The term “and/or”, e.g., “X and/or Y” shall be understood to mean either “X and Y” or “X or Y” and shall be taken to provide explicit support for both meanings or for either meaning.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the present specification, including definitions, will control. In addition, the materials, methods, and examples are illustrative only and not intended to be limiting.

The term “about” as used herein means within 5%, and more preferably within 1%, of a given value or range. For example, “about 3.7%” means from 3.5 to 3.9%, preferably from 3.66 to 3.74%. When the term “about” is associated with a range of values, e.g., “about X % to Y %”, the term “about” is intended to modify both the lower (X) and upper (Y) values of the recited range. For example, “about 20% to 40%” is equivalent to “about 20% to about 40%”.

### Specific Terms

The term ‘FAS’ as used herein refers to per- and polyfluoroalkylated substances (organic compounds) including, but not limited to, Perfluorobutanoic Acid (PFBA), Perfluoropentanoic Acid (PFPeA), 4:2 Fluorotelomer Sulfonic Acid (4:2 FTSA), Perfluorohexanoic Acid (PFHxA), Perfluorobutane Sulfonic Acid (PFBS), Perfluoroheptanoic Acid (PFHpA), Perfluoropentane Sulfonic Acid (PFPeS), 6:2 Fluorotelomer Sulfonic Acid (6:2 FTSA), Perfluorooctanoic Acid (PFOA), Perfluorohexane Sulfonic Acid (PFHxS), Perfluorohexane Sulfonic Acid-Linear (PFHxS-LN), Perfluorohexane Sulfonic Acid-Branched (PFHxS-BR), Perfluorononanoic Acid (PFNA), 8:2 Fluorotelomer Sulfonic Acid (8:2 FTSA), 10:2 Fluorotelomer Sulfonic Acid (10:2 FTSA), Perfluoroheptane Sulfonic Acid (PFHpS), Perfluorodecanoic Acid (PFDA), N-Methyl Perfluorooctane Sulfonamidoacetic Acid (N-MeFOSAA), N-Ethyl Perfluorooctane Sulfonamidoacetic Acid (EtFOSAA), Perfluorooctane Sulfonic Acid (PFOS), Perfluorooctane Sulfonic Acid-Linear (PFOS-LN), Perfluorooctane Sulfonic Acid-Branched (PFOS-BR), Perfluoroundecanoic Acid (PFUnDA), Perfluorononane Sulfonic Acid (PFNS), Perfluorododecanoic Acid (PFDoDA), Perfluorodecane Sulfonic Acid (PFDS), Perfluorotridecanoic Acid (PFTrDA), Perfluorooctane Sulfonamide (FOSA), N-Methyl Perfluorooctane Sulfonamide (Me-FOSA), N-Ethyl Perfluorooctane Sulfonamide (Et-FOSA), N-Methyl Perfluorooctane Sulfonamidoethanol (Me-FOSE), N-Ethyl Perfluorooctane Sulfonamidoethanol (Et-FOSE), Perfluorotetradecanoic Acid (PFTeDA), Nonafluoro-3,5-dioxaheptanoic acid (NFDHA), Hexafluoropropylene oxide dimer acid (HFPO-DA), 11-chloroeicosafluoro-3-oxaundecane-1-sulfonic acid (11CI-PF3OUds), 9-chlorohexadecafluoro-3-oxanone-1-sulfonic acid (9CI-PF3ONS) and 4,8-dioxa-3H-perfluorononanoic acid (ADONA).

The term ‘entry-point water’ as used herein refers to water discharged from a mains point of water inflow pipe connected with a potable water distribution system, such as a municipal water supply, bore water, or well water.

The term ‘FAS-free water’ as used herein refers to water having less than 0.01 μg/L or less total combined PFAS content.

The term ‘Iodine Number’ is defined as the milligrams of iodine adsorbed by one gram of carbon when the iodine concentration in the residual filtrate is 0.02 normal. It may be used as a measure of activity level of activated carbon, a higher number indicating a higher degree of activation. It also serves as an indicator of the micropore content of the activated carbon.

The term ‘pH-balancing media’ refers to an insoluble particulate material capable of raising (or lowering) the pH of water to a neutral pH of about 6.9 to about 7.2, as the water is passed through said insoluble particulate material.

### Filtration Arrangement

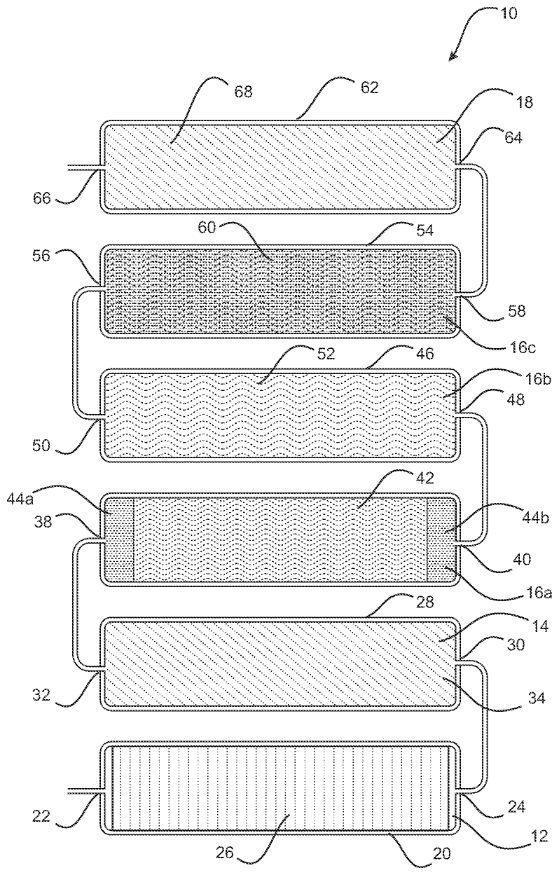

Referring to FIG. 1 there is shown a filtration arrangement 10 for removing PFAS contaminants from point-of-entry water. It will be appreciated that the filtration arrangement 10 will be suitably configured for conventional connection to a mains point of entry water inflow pipe and to operate under mains water pressure.

The filtration arrangement 10 includes a plurality of filtration cartridges arranged for series flow therethrough. Any suitable water filtration cartridges may be employed, such as 20 inch by 4.5 inch cartridges. In this particular embodiment, there are six (6) filtration cartridges arranged in series in fluid communication with one another and a point-of-entry water supply, including a pre-treatment filtration cartridge 12, a first filtration cartridge 14, three second filtration cartridges 16a, 16b, 16c and a post-treatment filtration cartridge 18.

The pre-treatment filtration cartridge 12 has a filtration body 20, an inflow port 22 for receiving point-of-entry water and an outflow port 24 for discharging pre-treated water to the first filtration cartridge 14. The filtration body 20 contains a filter bed 26 comprising a mechanical filter media, such as polypropylene. The polypropylene may have a particle size of about 1 μm, about 3 μm, about 5 μm or about 10 μm. Alternatively, the mechanical filter media may comprise polyester, cotton, cellulose, ceramic, glass fibre, sand, or a mixture thereof having a particle size of about 1 μm, about 3 μm, about 5 μm or about 10 μm.

The mechanical filter media mechanically filters influent water to remove sediment having a particle size of about >1 μm including, but not limited to, sand, fine suspensions including suspended organic matter, corrosion and scale products dislodged from the surface of pipes and water distribution installations, plastics, and fat solids.

The first filtration cartridge 14 has a filtration body 28, an inflow port 30 for receiving pre-treated water from the outflow port 24 of the preceding pre-treatment filtration cartridge 12, and an outflow port 32 for discharging water to a first of the second filtration cartridges 16a. The filtration body 28 contains a bed of a first filtration media comprising a mixture of calcined attapulgite clay, activated carbon and, optionally, a kinetic degradation fluxion media (KDF).

Attapulgite clay is a magnesium aluminium phyllosilicate clay with formula (Mg, Al)₂Si₄O₁₀(OH).4(H₂O). It has a high water absorption capacity and may form gel structures in water by establishing a lattice structure of particles connected through hydrogen bonds. Uncalcined attapulgite clay also has a tendency to form a slurry or slake under conditions where it is subjected to the water flow rates and water pressure typical for point-of-entry water filtration. This leads to filter bed failure and breakout of contaminated water. Advantageously, the inventor has found that calcined attapulgite clay is less likely to suffer from these detrimental characteristics.

The calcined attapulgite clay as described herein comprises attapulgite clay calcined at about 700° C. for about 1 hour. The resulting calcined attapulgite clay has a particle size range of about 0.9 mm to about 0.25 mm. Alternatively, the calcined attapulgite clay may have a particle size in a range of about 1.4 mm to about 3.35 mm. The calcined attapulgite clay may have a surface area greater than 90 m²/g.

The activated carbon as described herein may be granulated activated carbon (GAC) having a particle size range of about X-Y μm. The activated carbon may have a surface area from about X m²/g to about Y m²/g. The activated carbon may have a minimum Iodine Number of X.

Activated carbon is a known filter medium for removal of dissolved organic compounds (DOC) including some PFAS compounds. However, on its own it is not capable of removing a broad spectrum of PFAS compounds which may be present at low or trace levels in point-of-entry water. In particular, the inventor opines that DOC compete more strongly than PFAS compounds for binding sites on the activated carbon granules. The calcined attapulgite clay in the first filtration media facilitates, at least in part, removal of oils, heavy metals and dissolved organic carbon (DOC). The inventor has postulated that DOC preferentially binds with calcined attapulgite clay in the first filtration media, allowing the PFAS compounds to bind with activated carbon in the first filtration media or subsequently with the second filtration media in the second filtration cartridges 16a, 16b, 16c in the filtration arrangement 10. Consequently, the combination of activated carbon and uncalcined attapulgite facilitates long term removal of broad spectrum PFAS compounds, many to undetectable levels.

The first filtration media may optionally include a KDF media. The KDF media as described herein is a copper-zinc alloy that relies on the redox potential of dissolved oxygen in water in the presence of a zinc anode and a copper cathode. Ionic contaminants such as metal cations, chlorine and hydrogen sulphide may be removed by electrochemical conversion to a more physiological inert form. Suitable examples of KDF media include, but are not limited to KDF-55, a granular form of KDF media. Similarly, the presence of KDF media in the first filtration media removes contaminant species that would compete with PFAS compounds for binding sites on the activated carbon, thereby allowing at least some of the PFAS compounds to bind with activated carbon in the first filtration media or subsequently with the second filtration media in the second filtration cartridges 16a, 16b, 16c in the filtration arrangement 10.

The first filtration media may be prepared by mixing or blending 5-10 wt % calcined attapulgite clay, 85-95 wt % activated carbon and 0-5 wt % KDF media. The first filtration media may be loosely packed in the filtration body 28 at about 60% to about 70% volume capacity of the filtration body 28.

The first of the second filtration cartridges 16a has a filtration body 36, an inflow port 38 for receiving filtered water from the outflow port 32 of the preceding first filtration cartridge 14, and an outflow port 40 for discharging filtered water to a second of the second filtration cartridges 16b. The filtration body 36 contains a bed of a second filtration media comprising an ion exchange resin, optionally combined with activated carbon.

The ion exchange resin may be an anion exchange resin. Suitable examples of anion exchange resins include, but are not limited to, styrene-divinylbenzene copolymer resins that have quaternary ammonium functional groups. A mean diameter of said resin may be 675±75 μm.

The activated carbon may be as described previously.

The ion exchange resin may be arranged in a bed 42 in second filtration body 16a between a pair of opposing beds 44a, 44b of activated carbon disposed adjacent to the inflow port 38 and the outflow port 40, respectively, of the second filtration body 16a. In this arrangement, the activated carbon may occupy up to one third bed volume of the second filtration body 16a.

The second of the second filtration cartridges 16b has a filtration body 46, an inflow port 48 for receiving filtered water from the outflow port 40 of the preceding second filtration cartridge 16a, and an outflow port 50 for discharging filtered water to a third of the second filtration cartridges 16c.

The filtration body 46 may contain a bed 52 of anion exchange resin.

The third of the second filtration cartridges 16c has a filtration body 54, an inflow port 56 for receiving filtered water from the outflow port 50 of the preceding second filtration cartridge 16b, and an outflow port 58 for discharging filtered water to the post-treatment filtration cartridge 18.

The filtration body 54 may contain a bed 60 of anion exchange resin blended with activated carbon. The bed 60 may comprise anion exchange resin to activated carbon in a ratio of 3:1 to 2:1. The inventor has observed that the anion exchange resin frequently undergoes compaction with use. The presence of activated carbon in the second filtration media reduces the degree to which the anion exchange resin compacts.

The post-treatment filtration cartridge 18 has a filtration body 62, an inflow port 64 for receiving filtered water from the outflow port 58 of the preceding second filtration cartridge 16c, and an outflow port 66 for discharging PFAS-free water to a user. The post-treatment filtration cartridge 18 may be employed as a ‘polishing’ treatment, in particular to raise (or lower) the pH of the filtered water discharged from outflow port 58. For example, the inventor has observed that bore water treated according to the filtration arrangement 10 as described above may be discharged from outflow port 58 with a pH of about 6.3 to about 6.4. The pH of the filtered bore water may be increased to a more neutral pH of from 6.9 to 7.2 by passing said water through the post-treatment filtration cartridge 18.

The filtration body 62 may contain a bed 68 of a pH-balancing media. In one embodiment, the pH-balancing media may comprise the first filtration media, in particular a mixture of calcined attapulgite and activated carbon as described previously. In alternative embodiments, the pH-balancing media may comprise a mixture of calcite and activated carbon. Calcite may be present in an amount of up to 30 wt % of the mixture of calcite and activated carbon.

Alternatively, the filtration body 62 may contain a bed 68 of carbon block.

### EXAMPLES

The following examples are to be understood as illustrative only. It should therefore not be construed as limiting the embodiments of the disclosure in any way.

Point-of-entry water (100 kilolitres) contaminated with broad spectrum PFAS was passed through the filtration arrangement as described above with reference to FIG. 1. Pre-treatment and post-treatment concentrations were measured according to ARL No. 51 and are listed in the Table.

| | Pre- | Pre- | | Pre- | Pre- |
|---|---|---|---|---|---|
| | treatment | treatment | | treatment | treatment |
| Contaminant | (μg/L) | (μg/L) | Contaminant | (μg/L) | (μg/L) |
| PFBA | 0.012 | <0.008* | PFPeA | 0.02 | <0.002* |
| PFHxA | 0.1 | <0.001* | PFHpA | <0.004* | <0.004* |
| PFOA | 0.034 | <0.001* | PFNA | <0.002* | <0.002* |
| PFDA | <0.001* | <0.001* | PFUnDA | <0.001* | <0.001* |
| PFDoDA | <0.001* | <0.001* | PFTrDA | <0.001* | <0.001* |
| PFTeDA | <0.001* | <0.001* | PFBS | 0.072 | <0.002* |
| PFBA | 0.052 | <0.002* | PFHxS | 0.51 | <0.002* |
| PFHpS | 0.022 | <0.002* | PFOS | 0.22 | <0.004* |
| PFDS | <0.004* | <0.004* | (4:2)FTS | <0.008* | <0.008* |
| (6:2)FTS | <0.008* | <0.008* | (8:2)FTS | <0.002* | <0.002* |
| (10:2)FTS | <0.004* | <0.004* | FOSA | <0.004* | <0.004* |
| Me-FOSA | <0.004* | <0.004* | Et-FOSA | <0.004* | <0.004* |
| FOSAA | <0.002* | <0.002* | Me-FOSAA | <0.004* | <0.004* |
| Et-FOSAA | <0.004* | <0.004* | N-Me-FOSE | <0.008* | <0.008* |
| N-Et-FOSE | <0.008* | <0.008* | | | |

*Below practical quantifiable levels

The total PFAS contaminants in pre-treated water was measured as 1 μg/L. Subsequent treatment in the filtration arrangement as described herein reduced total PFAS to below practical quantifiable levels. Similarly, the sum of PFHxS and PFOS in pre-treated water was 0.73 ug/L, which was subsequently reduced to below practical quantifiable levels after treatment in the filtration arrangement as described herein.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

For example, in some embodiments, the three second filtration cartridges 16a, 16b, 16c may be replaced with a single 65 inch×14 inch vessel having an inflow port 38′ for receiving filtered water from the outflow port 32 of the preceding first filtration cartridge 14, and an outflow port 58′ for discharging filtered water to the post-treatment filtration cartridge 18. The vessel may contain the second filtration media as described above.

1. A filtration arrangement for removing PFAS contaminants from water, the filtration arrangement comprising:
at least one first filtration cartridge and at least one second filtration cartridge arranged for series flow therethrough,
the first filtration cartridge comprising a first filtration body having a first filtered water outflow port, a first inflow port for receiving influent water or for receiving filtered water from the first filtered water outflow port of an immediately preceding first filtration cartridge, and a first filtration media contained within the first filtration body, said first filtration media comprising a mixture of calcined attapulgite clay, activated carbon and, optionally, a kinetic degradation fluxion media (KDF),
the second filtration cartridge comprising a second filtration body having a second filtered water outflow port, a second inflow port for receiving filtered water from the first filtered water outflow port of an immediately preceding first filtration cartridge or from the second filtered water outflow port of an immediately preceding second filtration cartridge, and a second filtration media comprising an ion exchange resin and optionally activated carbon, contained within the second filtration body.

2. The filtration arrangement as defined in claim 1, wherein the filtration arrangement further comprises a pre-treatment filter cartridge comprising a filter body having a water inflow port for receiving a water inflow from a water supply system, a pre-treated water outflow port and a pre-treatment filtration media contained within the filter body, the pre-treatment filter cartridge being arranged in series flow to precede a first of the at least one first filtration cartridges, whereby the first water inflow port of said first filtration cartridge is arranged to receive pre-treated water from the pre-treated water outflow port.

3. The filtration arrangement as defined in claim 1, wherein the filtration arrangement further comprises a post-treatment filter cartridge arranged in series flow to receive filtered water from an immediately preceding second filtration cartridge of the filtration arrangement.

4. The filtration arrangement as defined in claim 3, wherein the post-treatment filter cartridge contains a pH-balancing media.

5. The filtration arrangement as defined in claim 1, wherein, in at least one of the second filtration cartridges, the ion exchange resin is mixed with activated carbon.

6. The filtration arrangement as defined in claim 1, wherein, in at least one of the second filtration cartridges, the ion exchange resin is arranged in a bed in the second filtration body between opposing beds of activated carbon disposed adjacent to the second inflow port and the second filtered water outflow port of the second filtration body, respectively.

7. The filtration arrangement as defined in claim 5, wherein the activated carbon occupies up to one third bed volume of the second filtration body.

8. The filtration arrangement as defined in claim 1, wherein the ion exchange resin comprises an anion exchange resin.

9. A filtration cartridge having a filtration body comprising a filtered water outflow port, a water inflow port for receiving water, and a first filtration media within the filtration body, said first filtration media comprising a mixture of calcined attapulgite clay, activated carbon and, optionally, a kinetic degradation fluxion media (KDF).

10. A method for removing PFAS contaminants from water, the method comprising:
passing an inflow of water from a water supply through a first filtration media comprising a mixture of calcined attapulgite clay, activated carbon and, optionally, a kinetic degradation fluxion media; and
passing an outflow of filtered water from the first filtration media through a second filtration media comprising an ion exchange resin and optionally activated carbon to produce PFAS-free water.

11. The method according to claim 10, wherein the method further comprises pre-treating the inflow of water from the water supply prior to passing said inflow through the first filtration media, wherein pre-treating said inflow comprises passing said inflow through a filter bed comprising a mechanical filter media.

12. The method according to claim 10, the method further comprising post-treating an outflow of water from the second filtration media, wherein post-treating said outflow comprises passing said outflow through a post-treatment bed comprising carbon block.

13. The method according to claim 10, the method further comprising post-treating an outflow of water from the second filtration media, wherein post-treating said outflow comprises passing said outflow through a pH-balancing media.

14. Use of a filtration media comprising calcined attapulgite clay, activated carbon and, optionally, a kinetic degradation fluxion media for removal of PFAS contaminants from water.

15. A filtration media comprising a mixture of calcined attapulgite clay, activated carbon and, optionally, a kinetic degradation fluxion media (KDF).

16. The filtration media according to claim 15, wherein the calcined attapulgite clay has a particle size range from about 0.9 mm to about 0.25 mm.

17. The filtration media according to claim 15, wherein the calcined attapulgite clay comprises attapulgite clay calcined at about 700° C. for about 1 hour.

18. The filtration media according to claim 15, wherein the calcined attapulgite clay has a surface area greater than 90 m²/g.

19. The filtration media according to claim 15, wherein the KDF media comprises KDF-55.

20. The filtration media according to claim 15, wherein the filtration media comprises a mixture of 5-10 wt % calcined attapulgite clay, 85-95 wt % activated carbon and 0-5 wt % KDF media.
